(19) United States
(12) Patent Application Publication
(10) Pub. No.: US 2013/0243266 A1
(43) Pub. Date: Sep. 19, 2013

(54) iPassport Apparatus and Method

(71) Applicant: L-1 SECURE CREDENTIALING, INC., Billerica, MA (US)

(72) Inventor: Mohamed Lazzouni, Northborough, MA (US)

(73) Assignee: L-1 SECURE CREDENTIALING, INC., Billerica, MA (US)

(21) Appl. No.: 13/803,214

(22) Filed: Mar. 14, 2013

Related U.S. Application Data
(60) Provisional application No. 61/611,737, filed on Mar. 16, 2012.

(51) Int. Cl. G06K 9/00

(52) U.S. Cl. CPC G06K 9/00885
USPC 382/115

(57) ABSTRACT

A portable hand-held device which includes on-board computer-implemented instructions to emulate identification documents such as a passport and interact with a computer terminal to determine whether the identified documents are authentic or not authentic.

### RELATED APPLICATIONS

This application claims priority to U.S. Provisional Application Ser. No. 61/611,737, filed Mar. 16, 2012, the entire contents of which are herein incorporated by reference.

### FIELD OF THE INVENTION

This invention relates to security documents and in particular to improvements in passport-type documents used by persons for identification and travel purposes.

### BACKGROUND

Passports up until recent times have been paper documents, generally in the form of a multipage book. Passports generally contain identification information about the holder of the passport as well as stamps and visas for the countries to which the holder of the passport has traveled.

In addition, today many countries are using so-called “ePassport” documents which are a modification of the old paper passport system but which contain an electronic contactless chip which contains certain identification information, including biometric information, concerning the holder of the passport.

The ICAO (International Civil Aviation Organization) has established standards for the biometrics file formats and communication protocols to be used in ePassports. This standard is called ISO/IEC 14443. Biometric passports include protection mechanisms whose objects are to prevent or detect potential unauthorized access to the contents of the contactless chip within the passport. These include Basic Access Control (BAC). BAC protects the communication channel between the chip and the card reader by encrypting transmitted information. Before data can be read from the contactless chip, the reader is required to provide a key which is derived from the so-called Machine-Readable Zone (MRZ). These may include the user's date of birth, the date of expiration of the document and the document number.

A second protection mechanism is the so-called Passive Authentication (PA). PA seeks to deter the modification of data which has been placed on the contactless chip within the passport. The contactless chip may contain a file which stores hash values of all files stored in the chip such as fingerprints, pictures, date of birth etc. and a digital signature of these hashes. Any changes to a file in the chip can be detected since the hash value would then be incorrect.

A third mechanism is called Active Authentication (AA). Active Authentication seeks to prevent cloning of passport chips. This is done through a structure in which the contactless chip contains a private key that cannot be either copied or read.

Finally, biometric passports may be equipped with so-called Extended Access Control (EAC). Extended Access Control adds functionality to check the authenticity of both the chip and the terminal on which the chip is read. It typically uses more stringent encryption algorithms than in basic access control and is used to protect fingerprints and typically iris scans.

Furthermore, it is known, including in US passports, to include a thin mesh covering over the chip to prevent unauthorized reading of the chip by an unauthorized third party.

### SUMMARY OF THE INVENTION

Today, even with the use of the present e-passport system, the system still depends on a paper book like device which is subject to being lost, mutilated, burned and which has, by its very nature, a limited amount of spaces into which various countries may mark visa information and entries and exits from other countries.

The present invention eliminates the paper form factor altogether and in fact eliminates the contactless electronic chip and emulates the function of both in an electronic form. This may be in the form of a so-called app may be downloaded to a smart phone or tablet such as those provided by Apple and other suppliers operating under the Droid OS.

Among the advantages of the software-derived passport, termed herein as the iPassport, is that it can be updated as desired, can contain as many entry and exit visas or entry points as desired and is better subject to being controlled. In addition, since a dedicated electronic contactless chip would not be feasible to incorporate in an otherwise standard smart phone or tablet, software is provided to the user in a downloaded app that would emulate the operation and structure of that chip, including all those protections that are afforded by the basic access control, passive authorization, active authentication, and extended access control.

It is envisioned that the iPassport would be, to the user, a transparent and exact or nearly exact replica of the paper-based passport, including showing the portrait of the user, identifying information and the MRZ. However, it is not merely an electronic duplicate of the paper passport. In addition, the iPassport contains an emulated contactless electronic chip that would be stored in memory within the smart phone or tablet and implemented using the smart phone hardware and OS. The iPassport output may be read by existing readers such as used by various border controls throughout the world to presently read ePassport data. In addition, the images contained in the iPassport can be protected against substitution or modification using digital watermarking techniques which are known in the art. In addition, renewing the iPassport will simply become a software update and even payment for passport renewal services can be done electronically through an electronic payment app which runs on the iPassport. Finally, if the tablet or smart phone which the iPassport has been implemented is ever stolen or lost, it is a simple matter of remotely rendering the app useless so that it does not get into the hands of undesirable third persons. The invention herein may also be applicable to national identity cards and drivers licenses.

In one embodiment, a non-transitory computer readable medium is encoded with computer instructions that, when executed by a processor contained within a handheld device having a display screen and an input and output device, is configured to: display one or more selected images relating to an identification document; communicate with an external computer device and output data relating to a person identified in the identification document, whereby the identification document is authenticated.

In another embodiment, the handheld device is one of a smartphone or a tablet.

In another embodiment, the identification document is a passport.

In another embodiment, the communication with the external computer device is compliant with the ISO 14443 standard.

In another embodiment, one or more of Basic Access Control and Active Authentication are supported.

In another embodiment, the passport includes a display of a MRZ area.

In another embodiment, the passport includes a display of an image of the person identified, further comprising digital watermarking of the image.

In another embodiment, the passport includes DWM techniques incorporated into images displayed on the display screen.

In another embodiment, a hand-held device for emulating identification documents comprises: a processor; a display; an input and an output device; a non-transitory computer readable medium encoded with computer instructions, that, when executed by the processor is configured to display one or more selected images relating to an identification document and communicate with an external computer device and output data relating to a person identified in the identification document, whereby the identification document is authenticated.

In another embodiment the handheld device is one of a smartphone or tablet.

In another embodiment, the identification document is a passport.

In another embodiment, the computer instructions further comprise an emulation of a computer hardware device that complies with the ISO 14443 standard.

In another embodiment, at least portions of the passport are displayed on the display and at least a portion of one or more images displayed include one or more digitally water-marked (DWM) images.

In another embodiment, the hand-held device further comprises a computer terminal external to the hand-held device, the computer terminal being connectable to the hand-held device and capable of extracting and processing the one or more digital water marked (DWM) images to determine whether the passport is authentic or non-authentic.

In another embodiment, the passport includes an emulation of a computer hardware device compliant with the ISO 14443 standard.

### BRIEF DESCRIPTION OF THE DRAWINGS

FIG. 1 illustrates a device with an image of the front cover of a passport being displayed

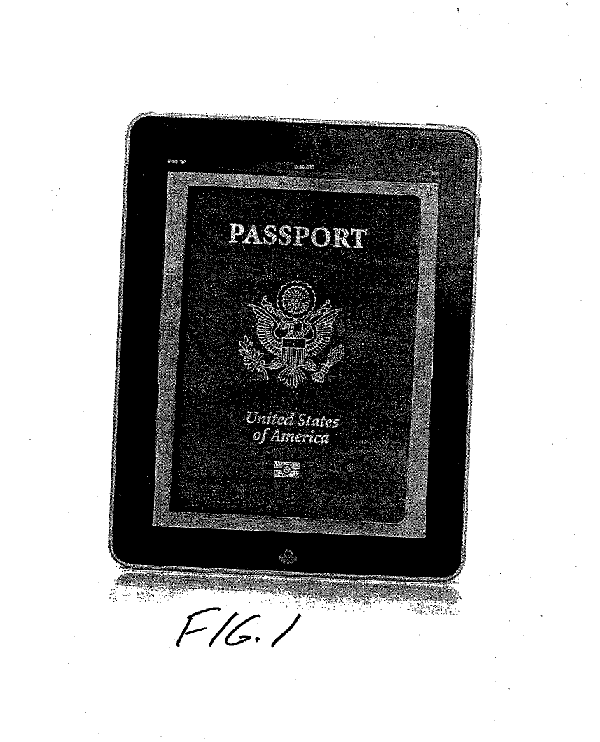

FIG. 2 illustrates a device with another image of an inside page of a passport displayed.

FIG. 3 illustrates an image of a page of a passport and the positioning of information thereon.

### DETAILED DESCRIPTION OF THE INVENTION

While, as discussed above, it has been known for many years to utilize paper passports or quasi electronic passports in the form of ePassports, up to the present time, there has been a reliance on a paper based passport, with the inherent issues of wear and tear, destruction and theft. With the increasing proliferation of so called smart phones and tablets, and the present ability to travel by air using an e-ticket based on an application downloaded to a person's smartphone or tablet, these devices are a convenient way of facilitating travel and eliminating the disadvantages of the paper based systems. Under an embodiment of the present invention, it is envisioned that the user would download an app to their smartphone, tablet, or other mobile device that would contain the essentials of an electronic passport. Once the iPassport has been installed, it would credential a full functional personalized passport booklet which can preferably mimic the paper form booklet currently used by various governments. However, it is important to note that the iPassport software application is not merely a electronic version or copy of the paper passport, but has further enhancements and functions which are not present in present day passports, as discussed below. Preferably, the software application to be downloaded into a smartphone or tablet device would fully simulate the current ePassport functionality via emulation of ISO 14443, biometric storage Basic Access Control and Active Authentication. Alternatively, the software application may rely on Digital Watermarks technology for security purposes, or both.

Thus, for persons who desire to leave behind paper based passports, such persons can rely on a passport application software that has been downloaded into their smartphone or tablet. Some of the features of the iPassport software application program are as follows:

(1) Given the security issues surrounding passports and theft of passports, the software application would be preferably downloaded through a secure channel, likely through a government source or a private contracted-for government source and installed in a user's phone or tablet after the user has been authenticated and validated, using present day techniques which are already available for authenticating users.

(2) The software application may display on the smartphone or tablet surface screen in a way that closely matches the paper based booklet with which users are familiar, thus keeping the same “look and feel”. As with other applications loaded on phones or tablets, like e-books, the user may progress from page to page by swiping a finger back and forth.

(3) The first inside passport page, the so called personalization page, will preferably be similar to that shown in a paper passport including a portrait area, personalized data of the user area and the MRZ area.

(4) The software application is preferably made to emulate at least preferably all current security levels contained in the present day e-passports.

As noted above, in addition to the printed features and other security features on present day passports, many modern passports, so called ePassports, also have a chip embedded in the passport to cross check credentials, speed up border crossing and enhance security. These chips are made in accordance with an ICAO specification, specifically ISO 14443 which specifies radio frequencies of 13.56 MHz. These chips are embedded within the paper structure of the passport and passport authority readers include known electronic equipment which can interrogate, authenticate, and download information from the embedded chip. Of course, in the present invention, it would not be possible to embed a separate chip within the structure of the smartphone or tablet; however, it is possible that the functionality of the ISO 14443 chip to be emulated in the software application program which is downloaded to the user's smartphone or tablet.

There are a number of basic functions which may be emulated in the software application program downloaded into the iPassport device. In present day paper ePassports, to ensure that chip data can be read only by authorized readers, Basic Access Control (BAC) stores a pair of cryptographic keys in the ePassport embedded chip, usual an RFID chip. When placed in the vicinity of the reader designed to read such chips, the reader attempts to scan the ePassport and engages in a challenge response protocol that proves knowledge of the pair of keys and then derives a session key. If the authentication is successful, the ePassport releases and downloads the data and content to the electronic reader. Of course, in the present invention, as mentioned above, without the separate embedded chip being introduced in the smartphone or tablet, the software application can emulate the basic access control.

In addition, ePassports may contain Active Authentication, which is an anti-cloning feature. Active Authentication relies on public key cryptography. It works by having the ePassport prove possession of a private key. The corresponding public key stored as part of the sign data on the ePassport. The public key for active authentication must be tied to the ePassport and biometric data presented. The ICAO specification mandates that Special Authentication occur in conjunction with an optical scan by the reader of the MRZ on an ePassport. Again, given the absence of a separate chip giving Active Authentication features, the software application will download and provide an emulation of Active Authentication. This emulation is performed by using the relatively sophisticated hardware contained in contemporary smartphones and tablets. The RFID chips used in ePassports have computation, cryptographic and storage capabilities that are well within the functional capabilities of contemporary smartphones and tablets. An emulation of the RFID chip functionalities may be downloaded into the smartphone or tablet at the time that the iPassport software program is downloaded into the smartphone or tablet device.

Other features and capabilities and utility of the present invention are as follows.

Digital watermarking techniques, well known in the art, may be incorporated into the application. A digital watermark (DWM) is embedded information in a digital signal such as pictures, audio, video or any other digital form of media. DWMs may be used, for example, to authenticate media (e.g. authenticate an identity document), identify the owner of media (e.g. a copyright), or communicate secret or hidden messages (e.g. steganography). If the signal is copied the DWM is also carried in the copy. A signal may carry several different DWMs at the same time. A DWM payload is the information or data embedded using a DWM.

A DWM may be visible, such as a text or logo embedded in an image, or invisible where the information cannot be perceived by the naked eye but may be detected by a suitable device. DWMs differ from metadata in that the data is carried directly in the signal. An objective of DWM is to attach ownership or information to a signal in a way that is difficult to remove. Digital watermarking systems and techniques are discussed in U.S. Pat. No. 7,694,887, entitled “Optically Variable Personalized Indicia for Identification Documents”, assigned to L-1 Secure Credentialing, Inc., the entire contents thereof which are incorporated herein by reference.

In regards to images, the DWM may be luminance-based. The DWM signal is embedded in signal intensity. Another form of DWM is chrominance-based. Chrominance-based DWMs embed information in a signal using values in the entire color spectrum. Chrominance-based DWMs are available from a number of sources, including a product named “Chroma”, available from Digimarc Corporation of Beaverton, Oreg. Luminance-based DWMs are also commercially available from a number of sources including Digimarc's “Classic” watermarking technology, again available from Digimarc Corporation of Beaverton, Oreg. Chrominance-based DWMs provide a number of advantages over luminance-based. Because the entire color spectrum is employed, the chrominance-based DWM signal can be stronger, less perceptible and more robust than a luminance-based DWM signal. Additionally, the integrity of the DWM is improved over the lifetime of a digital image, such as a credential, as chrominance-based DWMs are less susceptible to aging degradation.

Secure credentials can take many forms ranging from ID-credit card size to ID 3 passport size. Examples are a paper ePassport and the electronic iPassport of the present invention. DWMs may be placed on the ePassport or iPassport to reduce or prevent counterfeiting of the document and to help ensure the documents association with its legitimate holders. Exemplary information that may be embedded as a DWM in a paper ePassport or an iPassport may include information about the issuer, owner's name, owner's date of birth, card type, license number, document number, etc.

It is a known technique with paper-based security documents to place personalized information of the person named in the security document in an inconspicuous, hidden portion on the document in a much-reduced scale. The positioning and degree of magnification required may be known only to governmental authorities who can access this reduced scale writing and check it against other information, either on the document itself or on a remote database. In the context of the iPassport, similar hidden and much-reduced scale personalized information may be included on one or more of the “pages” of the iPassport, known only, for example, to passport control. When the person presents his or her iPassport, the passport control officer may use the touch magnification feature included in many smartphones and tablets to select the appropriate area on the “page” and enlarge it to determine whether the document is authentic or otherwise.

The present application also has the advantage over a paper passport in that adding pages beyond the given number of pages becomes simply a software update.

Renewing the passport also becomes simpler, as a user merely updates the software to revalidate the passport and extend the term of the passport's effectiveness. In addition, payment for passport services, such as renewals, can be done electronically through any number of known electronic payment options which run on the smartphones or tablets.

In operation, at the point of inspection or entry into a country, the passport immigration inspection officer may take possession of the smartphone or tablet device, open the software application containing the iPassport software application, review the contents and then connect to the device and run a reader application on the inspection officer's own computer system to authenticate the user's identity. Once authenticated, passport pages can then be appended with the date and port of entry information and other information electronically without the necessity of stamping as in present practice.

Just as paper passports get lost or stolen, so can smartphones or tablet devices. In the event of a smartphone or tablet being lost or stolen, once the user notifies the relevant authorities, the issuing authority may have the capability to render the software application useless by deleting or corrupting the data remotely using known communication techniques. Once a lost or stolen tablet or phone has had the software application corrupted or removed, a new device the user may acquire to download a replacement program through a secure process such as discussed above. In fact, some smartphones and tablets available presently possess the ability to be tracked by location in the event of loss or theft.

Also, should the phone or tablet not be stolen, but rather itself have a malfunction, the user may return to the original source of the secure software program and again download that software program.

It is envisioned that the software module which provides the ability to read and capture and analyze the information contained in the iPassport, including the DWM and/or of a computer hardware device complaint with IS 14443 may be available either from a vendor or, possibly, from an “app store” that can be downloaded from the app store with suitable secure payment facilities. Of course, given the security sensitivity of the authentication process, the downloading of the app or the software module may be excluded from a public app store and access may be restricted to the user downloading the app and/or software module from an approved vendor or from a governmental authority. Updates to the software may be automatically sent to the smart phone, tablet, or other portable device automatically in a “push” environment. It may also be envisioned that the smart phone, tablet, or other portable device may be required to be purchased from the vendor preloaded with further security applications to prevent the smart phone, should it be lost or stolen, to be used by unauthorized parties. Further enhancements may prevent the software module from falling into the wrong hands by utilizing a function contained in certain smart phones to detect the theft of the smart phone or other device, discussed above. Upon such detection of loss or of the device being stolen, the software module could, for example, automatically delete the iPassport software from the device to prevent the software module from being acquired by an unauthorized third party.

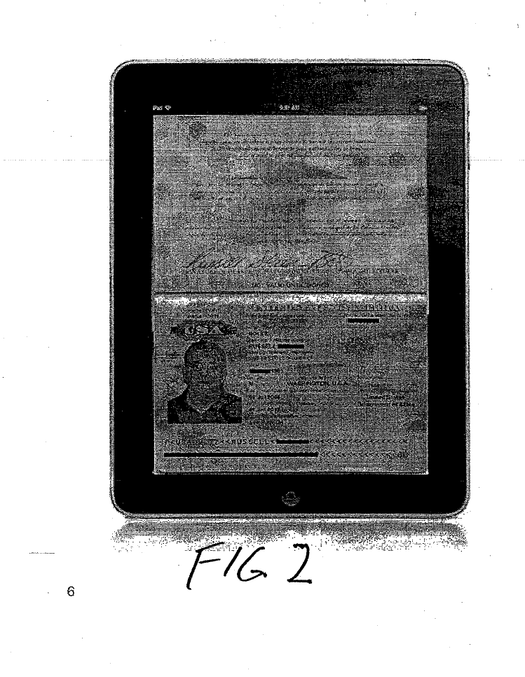

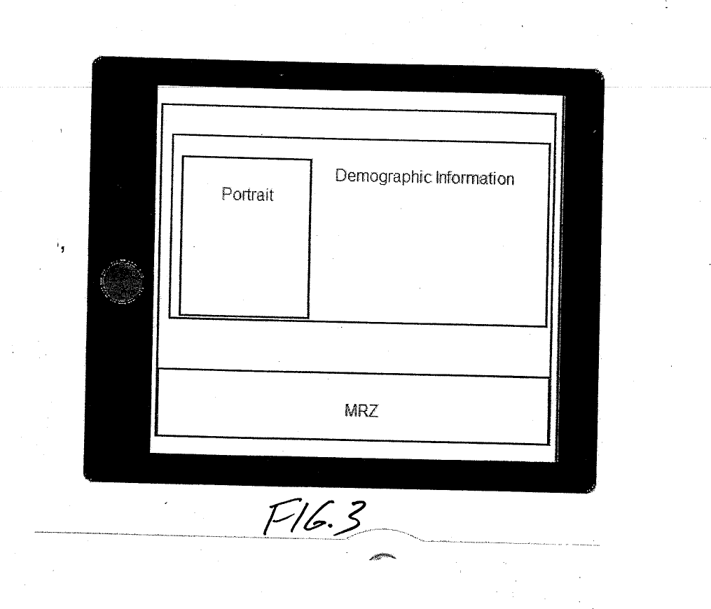

It is envisioned that, in the context of, for example, at a port of entry passport control station, the passport control officer may connect a smartphone or tablet containing the iPassport software to his or her terminal, open to the personal data page (see FIGS. 2 and 3) that may contain one or more DWMs, decode and examine the payload or message control in the DWM, and then authenticate the identity of the user through known techniques. Such techniques are described in co-pending application Ser. No. 13/777,483, filed Feb. 26, 2013, entitled: “Method and Apparatus for the Detection of Digital Watermarks for Instant Credential Authentication”, the entire disclosure of which is herein incorporated by reference.

While emulation of a RFID chip has been discussed, it is envisioned that DWM techniques may be used alongside the emulated RFID chip in the iPassport software for even greater security, or even used instead of an emulation of the RFID chip functionality.

The personalized (or other) page of the iPassport may also contain biometric features, well known in the art per se, to further protect against forgery and fraud. Such biometric features may be accessed by a passport control officer by connecting to the iPassport equipped smartphone or tablet, either wired or wirelessly. The officer may perform a local, in-person check, to see, for example, if the person standing before him/her matches the image of the person contained in the iPassport. Also, it is envisioned that certain biometric attributes may be sent to an offsite location for checking against certain lists, such as a “watch list” to determine if the person presenting the iPassport equipped smartphone or tablet is on that list and should be detained.

It is further envisioned that the onboard camera in many smartphones and tablets may provide another useful function. The user may use the onboard camera to take a self-portrait. Using known facial recognition technologies, the iPassport software may compare the facial features just captured by the onboard camera to the facial image of the person on the personalized page of the iPassport, and allow “opening” of that application only when there is a match. This feature may also be used by the passport control officer to authenticate the holder of the smartphone or tablet with the iPassport images.

Thus, it is envisioned that the inherent characteristics of an electronic version of a passport allows greater security capabilities. Whereas with a paper passport, the authentication process is largely “local”, that is, before the passport officer, the ability to transmit all or portions of the information contained in the iPassport to remote databases allows further checking and authentication.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit) as may be contained in the smartphone, tablet, or other mobile device.

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

Many kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input or input through an onboard camera.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Further, while the description above refers to the invention, the description may include more than one invention.

What is claimed is:

1. A non-transitory computer readable medium encoded with computer instructions that, when executed by a processor contained within a handheld device having a display screen and an input and an output device, is configured to:
(a) display one or more selected images relating to an identification document;
(b) communicate with an external computer device and output data relating to a person identified in the identification document, whereby the identification document is authenticated.

2. The computer-readable medium of claim 1 wherein the handheld device is one of a smartphone or a tablet.

3. The computer reader medium of claim 1 wherein the identification document is a passport.

4. The computer readable medium of claim 1 wherein the communication with the external computer device is compliant with the ISO 14443 standard.

5. The computer readable medium of claim 4, wherein one or more of Basic Access Control and Active Authentication are supported.

6. The non-transitory computer readable medium of claim 3, wherein the passport includes a display of a MRZ area.

7. The non-transitory computer readable medium of claim 3, wherein the passport includes a display of an image of the person identified, further comprising digital watermarking (DWM) of the image.

8. The non-transitory computer readable medium of claim 3, wherein the passport includes DWM techniques incorporated into images displayed on the display screen.

9. A hand-held device for emulating identification documents comprising:
a processor;
a display;
an input and an output device;
a non-transitory computer readable medium encoded with computer instructions, that, when executed by the processor is configured to:
display one or more selected images relating to an identification document and communicate with an external computer device and output data relating to a person identified in the identification document, whereby the identification document is authenticated.

10. The hand-held device of claim 9, wherein the identification document is a passport.

11. The hand-held device of claim 11, wherein the computer instructions further comprise an emulation of a computer hardware device that complies with the ISO 14443 standard.

12. The hand-held device of claim 1, wherein at least portions of the passport are displayed on the display and at least a portion of one or more images displayed include one or more digitally water-marked (DWM) images.

13. The hand-held device of claim 13, further comprising a computer terminal external to the hand-held device, the computer terminal being connectable to the hand-held device and capable of extracting and processing the one or more digital water marked (DWM) images to determine whether the passport is authentic or non-authentic.

14. The computer-readable medium of claim 3 wherein the passport includes an emulation of a computer hardware device compliant with the ISO 14443 standard.
